(19) United States
(12) Patent Application Publication
(10) Pub. No.: US 2011/0021648 A1
(43) Pub. Date: Jan. 27, 2011

(54) SILICONE FOAM WITH ADDED THERMAL AGENT AND USES OF THE FOAM

(75) Inventors: Thierry Guenard, Romilly Sur Seine (FR); Jean-Claude Boulanger, Mescrigny (FR); Annick Boccara, Etrelles Sur Aube (FR); Claude Boccara, Etrelles Sur Aube (FR)

Correspondence Address: J. Rodman Steele;Novak Druce & Quigg LLP, 525 Okeechobee Blvd, Suite 1500, West Palm Beach, FL, 33401, US

(73) Assignees: SOCIETE NATIONALE DES CHEMINS DE FER FRANCAIS, Paris (FR); FOTIA COMPOSITE, Etrelles Sur Aube (FR)

(21) Appl. No.: 12/447,681

(22) PCT Filed: Oct. 31, 2007
(86) PCT No.: PCT/FR2007/001814

§ 371 Date: Mar. 8, 2010

(30) Foreign Application Priority Data
Oct. 31, 2006 (FR) 0609566

(51) Int. Cl. C08J 9/35

(52) U.S. Cl. 521/55

(57) ABSTRACT

The foam comprises a mixture of silica, a polyorganosiloxane resin and a polyorganosiloxane hardener, added with a thermal insulator and an adhesion agent. The thermal insulator is ammonium polyphosphate. The foam is well appropriate as a filling and partitioning product in railway applications.

French patent application 05 05 848, not yet published, relates to an anticorrosive protection processing method for hollow bodies, including in the railway field, through an expanded foam bearing an anticorrosive agent and a flame retardant agent or a thermal insulator.

As for the processing foam, it is contemplated in this application to consider a silicone foam. It is also contemplated that a composition of PCT/BE95/00106, i.e. an inorganic resin comprising an aqueous solution of a metal phosphate of aluminium, zirconium, magnesium, zinc, calcium or iron, an oxy-boron compound and a wollastonite compound.

US H 1976 H also relates to an anticorrosive expanded plastic polymer for hollow bodies, more precisely an expanded foam with closed pores and even more precisely a diisocyanate resin.

Finally, DE 103 35 746 relates to a cold anticorrosive liquid resin for hollow bodies, that is expanded through a gas.

The invention of the present application also relates to the anticorrosive protection of hollow bodies, but not exclusively. In most cases, it relates in fact to a thermal protection material, a barrier material and in fact to a particular silicone foam.

Thus, the invention first relates to a silicone foam comprising a mixture of silica, a polyorganosiloxane resin and a polyorganosiloxane hardener, added with a thermal insulator.

The silicone foam, under the action of fire, turns again into silica form. It is a self-extinguishing material.

Then, by simply adding a thermal insulator to the silicone foam, the Applicants have observed that it gave a material that, beyond the self-extinguishing nature of the silicone foam, constituted a thermal and mechanical barrier to fire, a real flame protection!

It should be pointed out that it was audacious for the Applicant to propose to add a thermal insulator, i.e. a firewall agent, to a product that was already self-extinguishing. Their credit shows the inventive nature of their invention.

The foam of the invention can be applied in excessively multiple and various ways, whether it is used for filling or partitioning.

Again, the railway applications will be noticed with the railway cars and their frame and partition structures that can comprise flammable elements, such as wood floors. Comparable structures exist on board of automotive vehicles (automotive applications), planes (aeronautic applications) and other vessels (maritime applications). The thermal barriers can also be very interesting in tunnels and other sensitive locals (constructional and civil engineering applications), in the making of containers (storing and transportation applications), etc.

Preferably, ammonium polyphosphate is being considered as a thermal insulator.

In the preferred embodiment, the foam comprises the resin and the hardener in equal weight amounts.

Still preferably, the foam contains less than 10 wt% of thermal insulator, preferably, about 5% of the resin weight.

In the most advantageous embodiment, the resin and the hardener are the products marketed by Rhodia company under the protected trademarks Rhodorsil RT foam 3240 A and B®, respectively.

The foam of the invention can contain an adhesion agent, here aminopropyltriethoxysilane-3, in an amount of about 1 to 3% of the resin weight, preferably the agent marketed by Wacker-Chemie company under the protected trademark Geniosil GF 93®.

The foam of the invention can also contain, as an anticorrosive agent calcium soap in a quantity of about 1% of the resin weight, preferably the product marketed by Lockhart Chemical company under the protected trademark S 8855®.

The foam of the invention can also contain a soundproofing agent, preferably barium sulfate, advantageously in an amount of about 3 to 15% of the resin weight.

The implementation of the invention, i.e. the production and the use of the foam, is made in situ in the application site.

The resin and the hardener thereof are in a liquid form, as well as the adhesion agent Genosil and the anticorrosive agent Lockguard® while the barium sulfate and the ammonium polyphosphate are in a powder form.

The resin and the above mentioned functional fillers can first be mixed, the dosing being made by trial and error till obtaining the desired good proportions.

Then, the primary mixture thus obtained is mixed with the resin and homogenized before injecting, pouring or filling the final mixture product into the body to be processed or on the application site, so that the mixture reaction proceeds in an exothermal way and the foam is really formed and properly spread and applied. Then, by cooling, a skin effect is produced, which participates in the sealing and contributes to provide an anticorrosive function due to the absence of surface pores,

1. A silicone foam, comprising a mixture of silica, a polyorganosiloxane resin and a polyorganosiloxane hardener, added with a thermal insulator.

2. The silicone foam according to claim 1, wherein the thermal insulator is ammonium polyphosphate.

3. The silicone foam according to claim 1, wherein the resin and the hardener are equal in weight amounts.

4. The silicone foam according to claim 1, wherein less than 10 wt % of thermal insulator is provided.

5. The silicone foam according to claim 4, wherein the thermal insulator amount is about 5% of the resin weight.

6. The silicone foam according to claim 1, wherein the resin and the hardener are products marketed by Rhodia company under the protected trademarks Rhodorsil RT foam 3240 A and B®, respectively.

7. The silicone foam according to claim 1, wherein an adhesion agent is provided.

8. The silicone foam according to claim 7, wherein the adhesion agent is aminopropyltriethoxysilane-3.

9. The silicone foam according to claim 7, wherein the adhesion agent amount is about 1 to 3% of the resin weight.

10. The silicone foam according to claim 7, wherein the adhesion agent is the agent marketed by Wacker-Chemie company under the protected trademark Geniosil GF 93®.

11. The silicone foam according to claim 1, wherein calcium soap is provided as an anticorrosive agent.

12. The silicone foam according to claim 11, wherein the anticorrosive calcium soap is the product marketed by Lockhart Chemical company under the protected trademark Lockguard S 885S®.

13. The silicone foam according to claim 11, wherein the calcium soap quantity is about 1% of the resin weight.

14. The silicone foam according to claim 1, wherein a soundproofing agent is provided.

15. The silicone foam according to claim 14, wherein the soundproofing agent is barium sulfate.

16. The silicone foam according to claim 14, wherein the soundproofing agent amount is about 3 to 15% of the resin weight.

17. A method for imparting anticorrosive and thermal protection to a structural element, comprising: applying a silicone foam according to claim 1 to the structural element as a filling product.

18. A method for imparting anticorrosive and thermal protection to a structural element, comprising: applying a silicone foam according to claim 1 to the structural element as a partitioning product.

19-24. (canceled)

25. The method of claim 17, wherein the structural element is used in an application selected from the group consisting of railway applications, an automotive applications, aeronautic applications, maritime applications, construction and civil engineering applications, and storage and transportation applications.

26. The method of claim 18, wherein the structural element is used in an application selected from the group consisting of railway applications, an automotive applications, aeronautic applications, maritime applications, construction and civil engineering applications, and storage and transportation applications.
